(19) United States
(12) Patent Application Publication
(10) Pub. No.: US 2015/0193660 A1
(43) Pub. Date: Jul. 9, 2015

(54) COLLISION AVOIDANCE SYSTEM FOR MOBILE DEVICES

(71) Applicants: Eric Schimpff, Strongsville, OH (US); Richard Park Andersen, San Jose, CA (US)

(72) Inventors: ERIC SCHIMPFF, Strongsville, OH (US); RICHARD PARK ANDERSEN, San Jose, CA (US)

(21) Appl. No.: 14/588,969

(22) Filed: Jan. 4, 2015

Related U.S. Application Data
(60) Provisional application No. 61/923,660, filed on Jan. 4, 2014.
(60) Provisional application No. 61/923,659, filed on Jan. 4, 2014.

(51) Int. Cl. G06K 9/00; H04W 4/04; G06T 11/60

(52) U.S. Cl. CPC G06K 9/00671; G06T 11/60; H04W 4/043

(57) ABSTRACT

The present invention provides for a collision avoidance system integrated into a screen-based mobile device. The system includes either an integrated viewing camera or other sensor independent from the mobile device or a mechanism to utilize a viewing camera or other sensor which is integrated into the device by the device manufacturer or delivered through a software enhancement model supported by the device manufacturer.

### REFERENCE TO RELATED APPLICATION

This application is based on, and claims the benefit of priority to, U.S. provisional application Ser. No. 61/923,659, entitled “Collision Avoidance System for Mobile Devices” filed on Jan. 4, 2014, and U.S. provisional application Ser. No. 61/923,660, entitled “Collision Avoidance System for Electronic Handheld Devices” filed on Jan. 4, 2014, the content of which being incorporated in its entirety by reference herein.

### FIELD OF THE INVENTION

The present invention is in the technical field of mobile device applications. More particularly, the present invention is in the technical field of mobile navigation device applications.

### BACKGROUND OF THE INVENTION

Widely adopted mobile devices and smart phones, such as Apple iPhones, iPods and iPads or Nokia mobile phones running Microsoft Windows or Samsung mobile phones or tablets running Android are used very frequently in a manner requiring visual concentration on a display screen as they interact with applications such as the address book, telephone dialer, SMS/Texting, Map/GPS navigation, magazine or book reader, web browser, email client, music player, etc. The users also are frequently using these devices while in crowded locations such as cities, airports, shopping malls, event centers, or crossing streets or simply walking where there are potential obstacles or obstructions. As a result, users of these devices are experiencing collisions with other pedestrians, motorized and non-motorized vehicles, and stationary obstacles. In addition, the users may trip or fall as a result of not observing either something in their path or something moving toward them. The risk of being injured, causing injury, or even being the catalyst for physical property damage is significant and increasing as screen-based mobile devices proliferate.

Therefore, it would be desirable to provide a collision avoidance system for mobile devices.

### SUMMARY OF THE INVENTION

The present invention is a collision avoidance system integrated into a screen-based mobile device. The system includes either an integrated sensing mechanism that is an integrated viewing camera or other sensor independent from the mobile device or a sensing mechanism that utilizes a viewing camera or other sensor that is integrated into the device by the device manufacturer.

In one preferred embodiment of the invention, a process for providing an integrated, end-user operable collision avoidance system is disclosed. The process comprises the following steps: integrating a separate sensing and collision avoidance system with a mobile device; receiving data about the available surrounding area via the sensing mechanism; modifying or enhancing the data available to the sensing mechanism as it is being received by the sensing mechanism; transmitting data from the sensing mechanism to the mobile computing process through a transmission mechanism; interpreting data being received from the transmission mechanism in the form of information that can be displayed back to the device user; enhancing the information received from the sensing mechanism using additional information from the user or the device or additional data sources or additional applications, and displaying information to the user by means of a user interface.

In another preferred embodiment of the invention, the system contains an integrated mechanism that is dependent upon the mobile device sensor, and is connected to the mobile device via an electronic interface. Hardware augmentations are integrated into the system and are connected to the mobile device via the electronic interface. The system contains the following components: a sensing mechanism for receiving sensing data about the area available to the sensing mechanism; a means such as a hardware or/and software module for modifying or enhancing data available for the sensing mechanism; a means such as a hardware or/and software module for activating and deactivating the sensing mechanism; a transmission mechanism; a means such as a hardware or/and software module for interpreting sensing data; a means such as a hardware or/and software module for enhancing data by the means of interpreting data; and a user interface means for managing display of information manually or automatically.

In yet another preferred embodiment of the invention, the system interfaces and utilizes a sensing mechanism provided by the mobile device manufacturer, such as a built-in camera, and provides necessary hardware and software augmentation to provide the required collision avoidance capabilities. The hardware augmentations are integrated into the system, but are not connected to the mobile device via an electronic interface, and work in conjunction with the mobile device sensing mechanism. Enabling the hardware augmentation requires a manual step by the mobile device user. The system contains the following components: a means such as a hardware or/and software module for interfacing with and utilizing the mobile device sensing mechanism; a means such as a hardware or/and software module for augmenting the sensing mechanism; a transmission mechanism; a means such as a hardware or/and software module for interpreting sensing data; a means such as a hardware or/and software module for enhancing data by the means of interpreting data; and a user interface means for managing the display of information manually or automatically.

### BRIEF DESCRIPTION OF THE DRAWINGS

FIG. 1 is a schematic diagram illustrating the collision avoidance system 1000 according to one preferred embodiment of the present invention;

FIG. 2 is a schematic diagram illustrating the user interface means 1700 according to one preferred embodiment of the present invention;

FIG. 3 is a schematic diagram illustrating the collision avoidance system 2000 according to one preferred embodiment of present invention;

FIG. 4 is a schematic diagram illustrating various aspects of the information display mechanism 2700 according to one preferred embodiment of present invention;

FIG. 5 is a flowchart illustrating a process for operating the collision avoidance system 1000 according to one preferred embodiment of the present invention;

FIG. 6A and FIG. 6B are photographic illustrations of the collision avoidance system 1700, which contains the user interface means 1700 and the “layered” mode 1705; and

FIG. 7 is a photographic view of the collision avoidance system 1700 that contains the user interface means 1700 and a display band 1715 which is displayed at the top of the screen in this photograph.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

The present invention is a collision avoidance system integrated into a screen-based mobile device. The system includes either an integrated sensing mechanism that is an integrated viewing camera or other sensor independent from the mobile device or a sensing mechanism that utilizes a viewing camera or other sensor that is integrated into the device by the device manufacturer.

In one preferred embodiment of the invention, the system contains an integrated sensing mechanism that is independent from the mobile device. The system contains the following components: a sensing mechanism for receiving sensing data about the area available to the sensing mechanism; a means such as a hardware or/and software module for modifying or enhancing data available for the sensing mechanism; a means such as a hardware or/and software module for activating and deactivating the sensing mechanism; a transmission mechanism; a means such as a hardware or/and software module for interpreting sensing data; a means such as a hardware or/and software module for enhancing data by the means of interpreting data; and a user interface means for managing the display of information manually or automatically.

In another preferred embodiment of the invention, the system interfaces and utilizes a manufacturer or third-party integrated sensing mechanism. The system contains the following components: a means such as a hardware or/and software module for interfacing with and utilizing the integrated sensing mechanism; a means such as a hardware or/and software module for augmenting the sensing mechanism; a transmission mechanism; a means such as a hardware or/and software module for interpreting sensing data; a means such as a hardware or/and software module for enhancing the interpreted data; and a user interface means for managing display of information.

In another preferred embodiment of the invention, a process for operating a collision avoidance system is disclosed. The process comprises the following steps: attaching a collision avoidance system which is dependent upon a mobile device; receiving data about the available area by utilizing a sensing mechanism; modifying or enhancing data available to the sensing mechanism as it is being received by the sensing mechanism by means of modifying or enhancing data; receiving data from the sensing mechanism by utilizing a transmission mechanism; transmitting data from the sensing mechanism to the mobile computing process through a transmission mechanism; interpreting data being received from the transmission mechanism by a means of interpreting data in the form of information that can be displayed back to the device user; enhancing the information received from the sensing mechanism by a means of enhancing information using additional information from the user or the device or additional data sources or additional applications; and displaying information to the user by means of a user interface.

The collision avoidance system according to the invention is beneficial to the users in wireless telephonic and texting communications. The system includes a mobile or a handheld electronic device that has a display and wireless telephonic and texting capacities; a sensing device for measuring the range of the obstacles from the handheld electronic device; and a processor, such as CPU, in the handheld electronic device for computing the obstacle's distance. The processor, the sensing device and other components of the handheld electronic device are operatively coupled together. The processor calculates the rate of change of distance between the sensing device and the obstacle, estimating a time of intercept between the sensing device and the obstacle based on the rate.

The sensing device can be a separate device connected to the handheld electronic device via ribbon cable or other hardware connection, or a mechanism integrated into the handheld electronic device. In one implementation, the display screen has touch screen capabilities. In another implementation, the touch screen has a display icon integrated into the display, alerting user of a nearby obstruction. In another implementation, the sensing device measures angle and the processor estimates time of intercept additionally with path information based on the angle. Alternatively, the sensing device employs a camera, radar, or laser diode.

In the implementation where the sensing device and the handheld electronic device are not integrated in one single body, the collision avoidance system used in wireless telephonic and texting communications includes the following components: the sensing device for measuring the range of at least one obstacle; a connector being adapted for operatively coupling the sensing device to the handheld electronic device; and a mounting device being adapted for attaching the sensing device to the handheld electronic device.

The mounting device can be configured in different ways. As an example, the mounting device is adapted for top of the handheld electronic device. The mounting device offsets the sensing device by 25 to 35 degrees, preferably 30 degrees, from a lateral access of the handheld electronic device. Alternatively, the mounting device can be adapted for back of the handheld electronic device. In another implementation, the mounting device is a case for the handheld electronic device. Alternatively, the mounting device can be configured as a flap on a case for the handheld electronic device. The case has a processor operatively coupled to the sensing device and the connector.

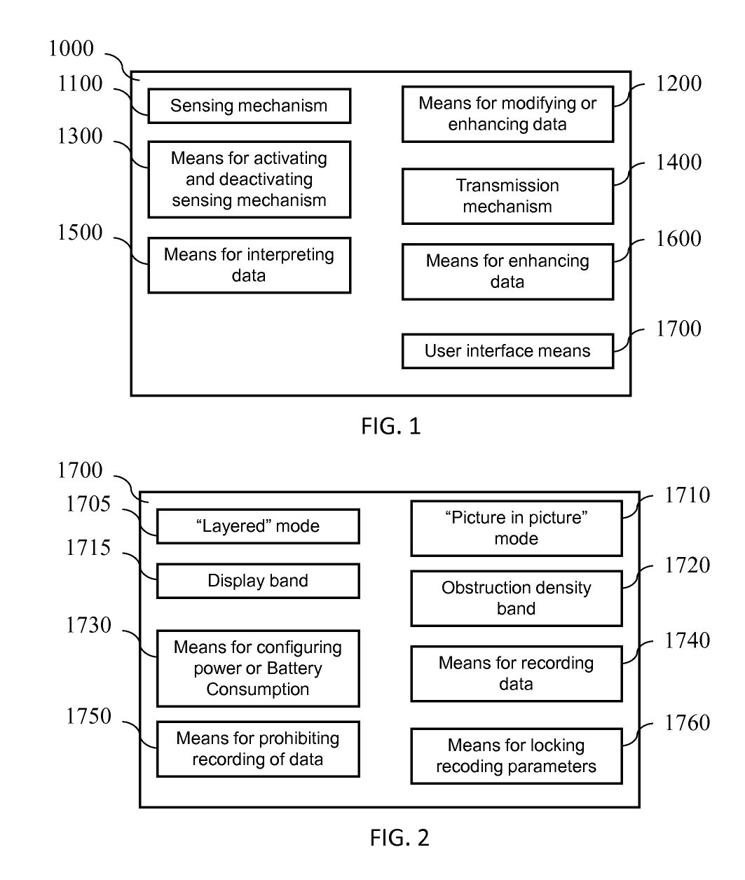

FIG. 1 is a schematic diagram illustrating the collision avoidance system 1000 according to one preferred embodiment of the present invention. The collision avoidance system 1000 comprises: a sensing mechanism 1100 for receiving sensing data about the area available to the sensing mechanism; a means such as a hardware or/and software module for modifying or enhancing data 1200 available for the sensing mechanism 1100; a means such as a hardware or/and software module for activating and deactivating 1300 the sensing mechanism 1100; a transmission mechanism 1400; a means such as a hardware or/and software module for interpreting sensing data 1500; a means such as a hardware or/and software module for enhancing data 1600 by the means of interpreting data 1500; and a user interface means 1700 for managing the display of information.

The sensing mechanism 1100 receives data about the area available to the sensing mechanism 1100. The sensing mechanism 1100 can be a viewing camera or sensor.

The means for modifying or enhancing the data 1200 available to the sensing mechanism 1100 functions as data is received by the sensing mechanism 1100 by utilizing optical components such as may be done with prisms or mirrors or electronic or logical manipulation. The means for modifying or enhancing the data 1200 can contain computer software that can be utilized by the sensing mechanism 1100 to perform the function to modify or enhance the data available to the sensing mechanism 1100.

The means for activating and deactivating 1300 the sensing mechanism 1100 is implemented as a hardware or software switching mechanism to activate or deactivate the collision avoidance system 1000.

The transmission mechanism 1400 receives data from the sensing mechanism 1100 and transmits the data to a mobile device computing processor that the system 1000 is attached to. The means for interpreting sensing data 1500 interprets sensing data being received from the transmission mechanism 1400 in the form of information that can be displayed back to the device user. The means for interpreting sensing data 1500 can be computer software or computer hardware or a combination of both. The means for enhancing data 1600 is utilized in conjunction with the means to interpret data 1500 to enhance the information received from the sensing mechanism 1100 and in addition may utilize additional information from the user or the device or additional data sources or additional applications.

The user interface means 1700 manages, manually or automatically the display of information for the device user, any user-configurable parameters associated with the display of information, and any user feedback instructions received during the activation or use of the system at any time.

FIG. 2 is a schematic diagram illustrating the user interface means 1700 according to one embodiment of the present invention. The user interface means 1700 comprises any combination among a plurality of components. The plurality of components include: “layered” mode 1705, “picture in picture” mode 1710, a display band 1715, an obstruction density band 1720, means for configuring power or battery consumption 1730, means for recording data 1740, means for prohibiting recording of data 1750, and means for locking recording parameters. The “layered” mode 1705 incorporates a background layer for the display of information useful for collision avoidance and one or more application's primary interface in the foreground layer. Either the foreground or background layer made be made brighter or dimmer by varying the opacity of either. The “picture in picture” mode 1710 is similar to what is found on televisions. The display band 1715 is displayed at the top of the screen or can be repositioned by the user. The obstruction density band 1720 is displayed at the top of the screen or can be repositioned by the user. It displays information similar to the way radar systems display information. The user may adjust brightness and vary the opacity of the various information display elements. The means for configuring battery power consumption 1730 may contain a low-power option that may utilize a different sensing or digital sampling algorithm, or user-configurable brightness or other parameters. The means for recording data 1740 records a variable amount of data received by the sensing mechanism 1100. The means for prohibiting recording data 1750 prohibits any recording of data received by the sensing mechanism 1100. The means for locking recording parameters 1760 locks data recording parameters in such a manner so that it would not be a user configurable option.

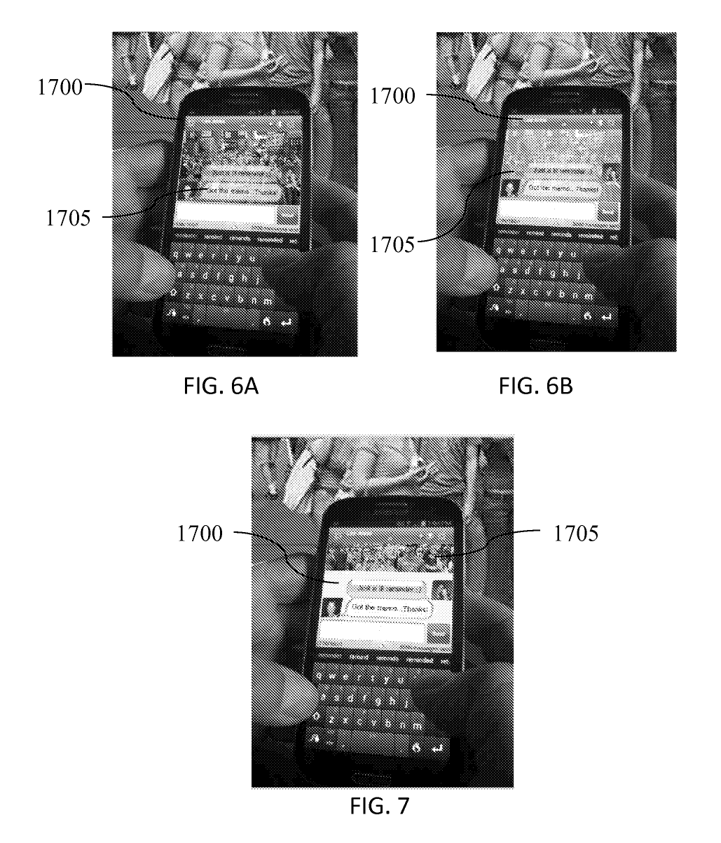

Referring to FIG. 6A and FIG. 6B that are photographs of the collision avoidance system 1700, containing the user interface means 1700, which contains “layered” mode 1705. The “layered” mode 1705 incorporates a background layer for the display of information useful for collision avoidance and one or more application's primary interface in the foreground layer. In FIG. 6A, the background layer is displayed with high brightness. FIG. 6B, the background layer is displayed with low brightness.

Referring to FIG. 7 that is a photograph of the collision avoidance system 1700, which contains the user interface means 1700, which contains a display band 1715. The display band 1715 is displayed at the top of the screen in this photograph.

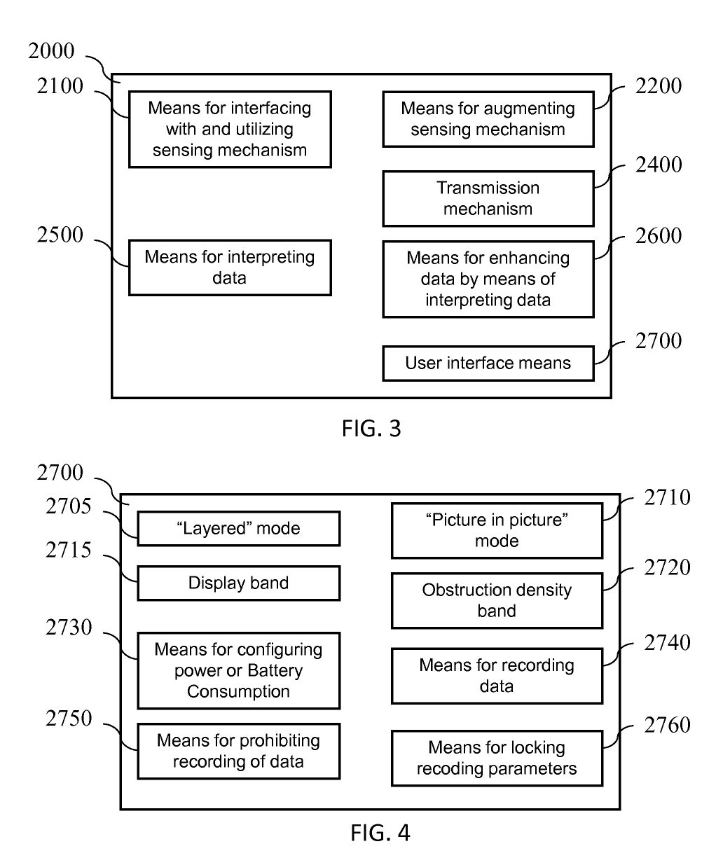

Illustrated in FIG. 3 is a schematic diagram for the collision avoidance system 2000 according to another preferred embodiment of the present invention. The collision avoidance system 2000 interfaces and utilizes a manufacturer or third-party integrated sensing mechanism on the mobile device. The collision avoidance system 2000 comprises: a means such as a hardware or/and software module for interfacing with and utilizing the integrated sensing mechanism 2100; a means such as a hardware or/and software module for augmenting the sensing mechanism; a transmission mechanism 2400; a means such as a hardware or/and software module for interpreting sensing data 2500; a means such as a hardware or/and software module for enhancing data 2600 by the means of interpreting data 2500; and a user interface means 2700 for managing display of information manually or automatically.

The means for interfacing with and utilizing the integrated sensing mechanism 2100 interfaces with and utilizes a manufacturer or third-party integrated sensing mechanism to receive data about the area available to the sensing mechanism. The sensing mechanism can be a viewing camera or sensor.

The means for augmenting the sensing mechanism 2200 augments the sensing mechanism by utilizing optical components or manipulation logic such as may be done with prisms or mirrors to modify or enhance data available to the sensing mechanism or as it is being received by the sensing mechanism. The means for augmenting the sensing mechanism 2200 can contain computer software that can be utilized by the sensing mechanism to perform the function of modifying or enhancing the data available to the sensing mechanism.

The transmission mechanism 2400 receives data from the sensing mechanism and transmits the data to a mobile device computing processor that the system 2000 is attached to. The means for interpreting sensing data 2500 interprets sensing data being received from the transmission mechanism 2400 in the form of information that can be displayed back to the device user. The means for interpreting sensing data 2500 can be computer software or computer hardware. The means for enhancing information 2600 is used by the means to interpret data 2500 to enhance the information received from the sensing mechanism using additional information from the user or the device or additional data sources or additional applications.

The user interface means 2700 manages, manually or automatically, the display of information for the device user, any user-configurable parameters associated with the display of information, and any user feedback instructions received during the activation or use of the system at any time.

FIG. 4 is a schematic diagram illustrating the user interface means 2700 according to one embodiment of the present invention. The user interface means 2700 comprises any combination among a plurality of components. The plurality of components include: “layered” mode 2705, “picture in picture” mode 2710, a display band 2715, an obstruction density band 2720, means for configuring power or battery consumption 2730, means for recording data 2740, means for prohibiting recording of data 2750, and means for locking recording parameters. The “layered” mode 2705 incorporates a background layer for the display of information useful for collision avoidance and one or more application's primary interface in the foreground layer. Either the foreground or background layer made be made brighter or dimmer by varying the opacity of either. The “picture in picture” mode 2710 is similar to what is found on televisions. The display band 2715 is displayed at the top of the screen or can be repositioned by the user. The obstruction density band 2720 is displayed at the top of screen or may be repositioned by the user. It works similar to the way radar systems display information. The user may adjust brightness and vary the opacity of the various information display elements. The means for configuring battery power consumption 2730 may contains a low-power option that may utilize a different sensing or digital sampling algorithm, or user-configurable brightness or other parameters. The means for recording data 2740 records a variable amount of data received by the sensing mechanism. The means for prohibiting recording data 2750 prohibits any recording of data received by the sensing mechanism. The means for locking recording parameters 2760 locks data recording parameters in such a manner so that it would not be a user configurable option.

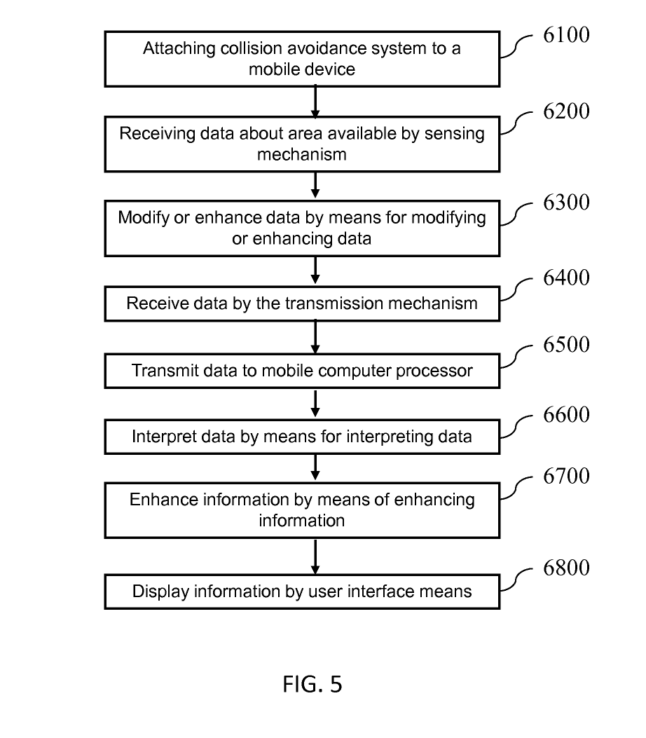

FIG. 5 is a flowchart illustrating a process for operating the collision avoidance system 1000 according to one preferred embodiment of the present invention. The process for operating the collision avoidance system 1000, comprising the following steps:

Step 6100: Attaching collision avoidance system 1000 to a mobile device;

Step 6200: Receiving data about area available by the sensing mechanism 1100;

Step 6300: Modifying or enhancing data available to the sensing mechanism 1100 or as it is being received by the sensing mechanism 1100 by means for modifying or enhancing data 1200;

Step 6400: Receiving data from the sensing mechanism 1100 via the transmission mechanism 1400;

Step 6500: Transmitting data from the sensing mechanism 1100 to the mobile computing process via the transmission mechanism 1400;

Step 6600: Interpreting data being received from the transmission mechanism 1400 by the means for interpreting data 1500 in the form of information that can be displayed back to the device user;

Step 6700: Enhancing the information received from the sensing mechanism 1000 by the means for enhancing information using additional information from the user or the device or additional data sources or additional applications; and

Step 6800: Displaying information to the user via the user interface means 1700.

While one or more embodiments of the present invention have been illustrated above, the skilled artisan will appreciate that modifications and adoptions to those embodiments may be made without departing from the scope and spirit of the present invention.

1. A collision avoidance system, comprising: a sensing device integrated into a screen-based mobile device, wherein said a sensing device comprises means for receiving data about the available surrounding area, means for modifying and enhancing the data as it is being received by said sensing mechanism, and means for transmitting the enhanced data from said sensing mechanism to a processor in said screen-based mobile device, wherein said screen-based mobile device comprises means for interpreting data being received from the transmission means, means for displaying information in the mobile device's screen such that a user avoids physical collisions with the surrounding environment while operating said mobile device and visually focusing on the screen.

2. The collision avoidance system of claim 1 wherein the information displayed on the screen visually reflects the surrounding area.

3. A collision avoidance system integrated through hardware or software into a screen-based mobile device, comprising: an integrated mechanism dependent upon a mobile device sensor, which is connected to the mobile device via an electronic interface; means for hardware augmentation integrated into said integrated mechanism and connected to the mobile device via said electronic interface; a sensing mechanism receiving sensing data about the area available to said sensing mechanism; means for modifying or enhancing data available; a transmission mechanism to interpret information; means for enhancing sensing data; and a user interface for managing the display of information manually or automatically to help a user avoid physical collisions with the surrounding environment while operating said mobile device.

4. The collision avoidance system of claim 3 further comprising an electronic interface with a picture in picture mode.

5. The collision avoidance system of claim 3 further comprising an electronic interface with a layered mode.

6. The collision avoidance system of claim 3 further comprising an electronic interface with a display band.

7. The collision avoidance system of claim 3 further comprising an electronic interface with an obstruction density band.

8. The collision avoidance system of claim 3 further comprising an option to control brightness of display for low battery power consumption.

9. The collision avoidance system of claim 3 further comprising means for recording data.

10. The collision avoidance system of claim 3 further comprising means for prohibiting recording of data.

11. The collision avoidance system of claim 3 further comprising means for locking recoding parameters.

12. A collision avoidance system built into a screen-based mobile device at the time of manufacture, benefiting from design and manufacturing optimizations, said system comprising: a sensing mechanism provided by a built-in camera of said mobile device, a means for hardware and software augmentation, said hardware and software augmentation working in conjunction with said mobile sensing mechanism and not connected to the mobile device, said sensing mechanism interprets data, transmits data, and a user interface on said mobile device manages the display of information manually or automatically to help avoid physical collisions with the surrounding environment while operating said mobile device.

13. The collision avoidance system of claim 12 further comprising an electronic interface with a picture in picture mode.

14. The collision avoidance system of claim 12 further comprising an electronic interface with a layered mode.

15. The collision avoidance system of claim 12 further comprising an electronic interface with a display band.

16. The collision avoidance system of claim 12 further comprising an electronic interface with an obstruction density band.

17. The collision avoidance system of claim 12 further comprising an option to control brightness of display for low battery power consumption.

18. The collision avoidance system of claim 12 further comprising a means for recording data.

19. The collision avoidance system of claim 13 further comprising a means for prohibiting recording of data.

20. The collision avoidance system of claim 13 further comprising means for locking recoding parameters.
